(19) United States
(12) Patent Application Publication
(10) Pub. No.: US 2012/0048258 A1
(43) Pub. Date: Mar. 1, 2012

(54) ADJUSTABLE GRATE FOOT FOR HOME APPLIANCE

(75) Inventors: Norman Sewell, New Bern, NC (US); Troy Wilson, Cove City, NC (US); Anthony Zymroz, JR., Trenton, NC (US)

(73) Assignee: BSH HOME APPLIANCES CORPORATION, Huntington Beach, CA (US)

(21) Appl. No.: 12/872,189

(22) Filed: Aug. 31, 2010

(51) Int. Cl. F23H 13/00; F16M 11/24

(52) U.S. Cl. 126/152 A; 248/157

(57) ABSTRACT

An adjustable foot assembly for a pan support of a home appliance is provided. The assembly includes a first bushing having an inside threaded surface on an inner surface, and outside threaded surface on an outer surface; a set screw having an outside threaded surface on an outer surface, the outside threaded surface of the set screw engaging the inside threaded surface of the first bushing such that the set screw is movable relative to the first bushing along a first direction; and a contact foot attached to the first bushing. The first bushing and the set screw are adapted to allow the set screw to be moved relative to the first bushing as the set screw is moved into contact with the pan support, the relative movement being allowed by the outside threaded surface of the set screw moving relative to the inside threaded surface of the first bushing.

### FIELD OF THE INVENTION

The invention is directed to a foot for a grate or pan support, and, more particularly, to an adjustable grate foot that stabilizes a grate or pan support.

An example of an application for the invention is a foot on a grate or pan support of a household gas cook top.

### BACKGROUND OF THE INVENTION

Many home appliances, such as, for example, gas cook tops, have a grate or pan support that is positioned above a heat source, such as a gas burner. The grate often sits on a sheet metal upper surface, or mainsheet, of the cook top and is supported by a number of feet. Often four or six feet are used to support a single grate. Grates are usually made of a rigid, strong, material such as cast metal. Because the grates are rigid and are usually supported by more than three feet, the grates have a tendency to rock due to the grate or the mainsheet not being perfectly flat.

Some grates include rubber feet fixed to the grate at the points where the grate contacts the cook top. However, these rubber feet do not always eliminate rocking of the grate.

A rocking grate can be an unstable support for a pan being used on the cook top, which can result in spilled food items and/or an unlevel cooking surface. A grate that is not stable and tends to rock also gives an appearance of low quality to the cook top.

### SUMMARY

The invention recognizes that it is desirable to provide a stable foundation for a grate on a cook top. Exemplary embodiments of the invention provide an adjustable grate foot that stabilizes the grate on the mainsheet. This adjustability can be provided in different ways, but may include an embodiment of the foot that is threaded to move up and down within the grate when rotated relative to the grate.

In particular embodiments, a grate having four feet is provided with two fixed feet adjacent one another and two adjustable feet opposite the two fixed feet. The fixed feet establish and maintain a desired predetermined height of the grate above the gas burners and the adjustable feet can be adjusted to adapt to the surface on which the grate rests. Other embodiments include only one adjustable foot, while still other embodiments provide an adjustable foot at all or all but one foot position.

Particular embodiments of the invention are directed to an adjustable foot assembly for a pan support of a home appliance, the foot assembly comprising: a first bushing having an inside threaded surface on an inner surface, and outside threaded surface on an outer surface; a set screw having an outside threaded surface on an outer surface, the outside threaded surface of the set screw engaging the inside threaded surface of the first bushing such that the set screw is movable relative to the first bushing along a first direction; and a contact foot attached to the first bushing. The first bushing and the set screw are adapted to allow the set screw to be moved relative to the first bushing as the set screw is moved into contact with the pan support, the relative movement being allowed by the outside threaded surface of the set screw moving relative to the inside threaded surface of the first bushing.

Other embodiments of the invention are directed to a grate for a home appliance, the grate comprising: a pan support having a recess; and an adjustable foot assembly positioned at least partially in the recess, the foot assembly comprising: a first bushing having an inside threaded surface on an inner surface, and outside threaded surface on an outer surface; a set screw having an outside threaded surface on an outer surface, the outside threaded surface of the set screw engaging the inside threaded surface of the first bushing such that the set screw is movable relative to the first bushing along a first direction; and a contact foot attached to the first bushing. The first bushing and the set screw are adapted to allow the set screw to be moved relative to the first bushing as the set screw is moved into contact with the recess, the relative movement being allowed by the outside threaded surface of the set screw moving relative to the inside threaded surface of the first bushing.

Other embodiments of the invention are directed to an adjustable foot assembly for a pan support of a home appliance, the foot assembly comprising: a bushing having an outside threaded surface on an outer surface, the outside threaded surface being adapted to engage an inside threaded surface of a recess in the pan support; and a contact foot attached to the first bushing. The first bushing has a round cross section and the contact foot has a round contact patch for contacting the home appliance.

Other embodiments of the invention are directed to a home appliance, the home appliance comprising: a support surface; a pan support located on the support surface and for supporting a pan to be positioned above the home appliance, the pan support having a recess; and an adjustable foot assembly positioned at least partially in the recess, the foot assembly comprising: a first bushing having an inside threaded surface on an inner surface, and outside threaded surface on an outer surface; a set screw having an outside threaded surface on an outer surface, the outside threaded surface of the set screw engaging the inside threaded surface of the first bushing such that the set screw is movable relative to the first bushing along a first direction; and a contact foot attached to the first bushing. The first bushing and the set screw are adapted to allow the set screw to be moved relative to the first bushing as the set screw is moved into contact with the recess, the relative movement being allowed by the outside threaded surface of the set screw moving relative to the inside threaded surface of the first bushing.

### BRIEF DESCRIPTION OF THE DRAWINGS

The following figures form part of the present specification and are included to further demonstrate certain aspects of the disclosed features and functions, and should not be used to limit or define the disclosed features and functions. Consequently, a more complete understanding of the exemplary embodiments and further features and advantages thereof may be acquired by referring to the following description taken in conjunction with the accompanying drawings, wherein:

FIG. 1 is a perspective view of a grate that is an exemplary embodiment of the invention;

FIG. 2 is a sectional view of an exemplary embodiment of the invention;

FIG. 3 is an exploded view of the exemplary embodiment shown in FIG. 2;

FIG. 4 is a top view of the exemplary embodiment shown in FIG. 2;

FIG. 5 is a side view of the exemplary embodiment shown in FIG. 2;

FIG. 6 is a bottom view of the exemplary embodiment shown in FIG. 2;

FIG. 7 is a perspective view of a portion of a second exemplary embodiment of the invention;

FIG. 8 is a perspective view of a portion of a second exemplary embodiment of the invention;

FIG. 9 is a perspective view of a portion of a second exemplary embodiment of the invention;

FIG. 10 is a perspective view of a portion of a third exemplary embodiment of the invention;

FIG. 11 is a perspective view of a portion of a third exemplary embodiment of the invention;

FIG. 12 is a sectional view of the third exemplary embodiment of the invention; and

FIG. 13 shows a home appliance in accordance with exemplary embodiments of the invention.

### DETAILED DESCRIPTION

The invention is described herein with reference to the accompanying drawings in which exemplary embodiments of the invention are shown. The invention may, however, be embodied in many different forms and should not be construed as limited to the embodiments set forth herein.

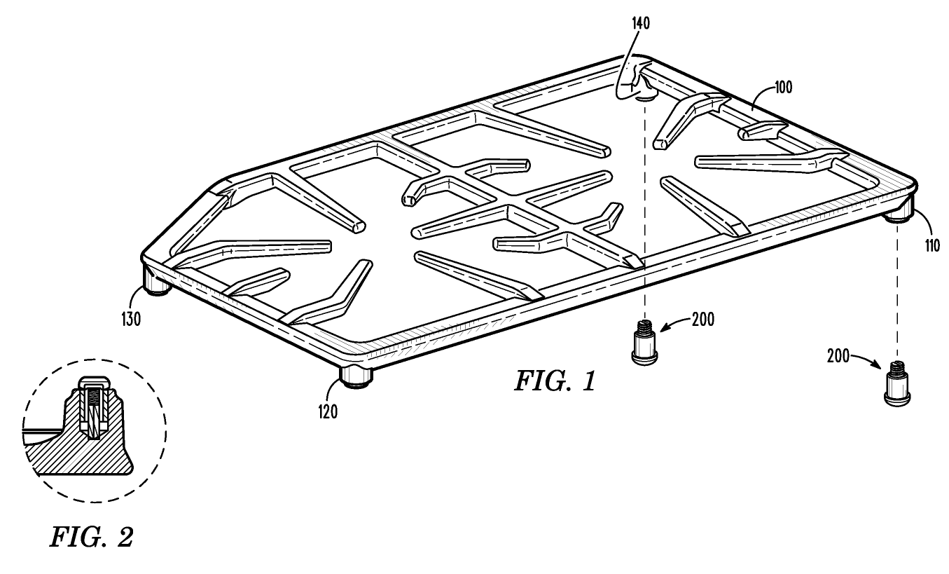

FIG. 1 shows an example of a pan support, or grate, 100. Grate 100 can be one of several grates positioned above, for example, burners on a gas cook top to support pans and other cooking utensils. In this example, grate 100 has four extensions 110, 120, 130, 140. However, other numbers of extensions can be used. For example, some grates have six extensions. Because grate 100 has multiple (usually more than three) contact points on which it is supported, rocking can occur due to manufacturing tolerances in grate 100 and/or the surface on which grate 100 rests. The invention addresses this problem and provides a solution in the form of one or more adjustable feet that are inserted into one or more of the extensions. In the example shown in FIG. 1, an adjustable foot assembly 200 is shown for inserting into each of extension 110 and extension 140. FIG. 2 shows a sectional view of foot assembly 200 inserted into one of the extensions.

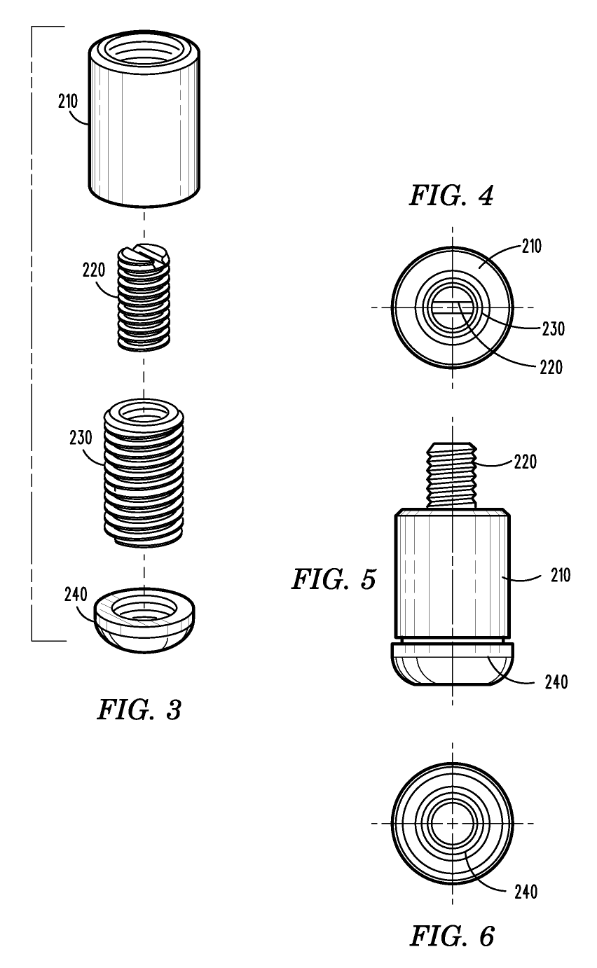

FIGS. 3-6 show a first exemplary embodiment of the invention. FIG. 3 is an exploded view of an adjustable foot assembly having a first bushing 210, a set screw 220, a double threaded bushing 230, and a foot 240. Foot 240 is attached to double threaded bushing 230 by, for example, a pressfit or a threaded connection such that foot 240 is fixed relative to double threaded bushing 230. Threads on the outside of double threaded bushing 230 engage threads on the inside of first bushing 210 such that the position of double threaded bushing 230 (and thus foot 240) is adjustable relative to first bushing 210. Threads on the outside of set screw 220 engage threads on the inside of double threaded bushing 230 such that the position of set screw 220 is adjustable relative to double threaded bushing 230.

FIGS. 4, 5 and 6 are a top view, side view, and bottom view, respectively, of the embodiment shown in FIG. 3 in an assembled state. In FIGS. 4-6, double threaded bushing 230 is screwed completely into first bushing 210. The assembly can be pressed into a recess in one of the extensions of grate 100 (see FIG. 2). The outside of first bushing 210 can be smooth or have a textured finish such as, for example, a knurled finish. A textured finish can result in a more secure interference fit between first bushing 210 and the recess.

The length of the assembly can be adjusted by rotating double threaded bushing 230 relative to first bushing 210. After the assembly has been adjusted to the desired length, it's length can be secured by rotating set screw 220 relative to double threaded bushing 230 until a first end of set screw 220 comes in contact with, and is pressed firmly against, the bottom of the recess (as shown in FIG. 2). A second end of set screw 220 opposite the first end can have, for example, a slot or recess for receiving a screw driver or an allen wrench. Foot 240 can be removable to allow access to the second end of set screw 220, or foot 240 can have a hole in it to allow access to the second end of set screw 220. In the case of a removable foot 240, foot 240 is repositioned on double threaded bushing 230 after the assembly is adjusted and secured.

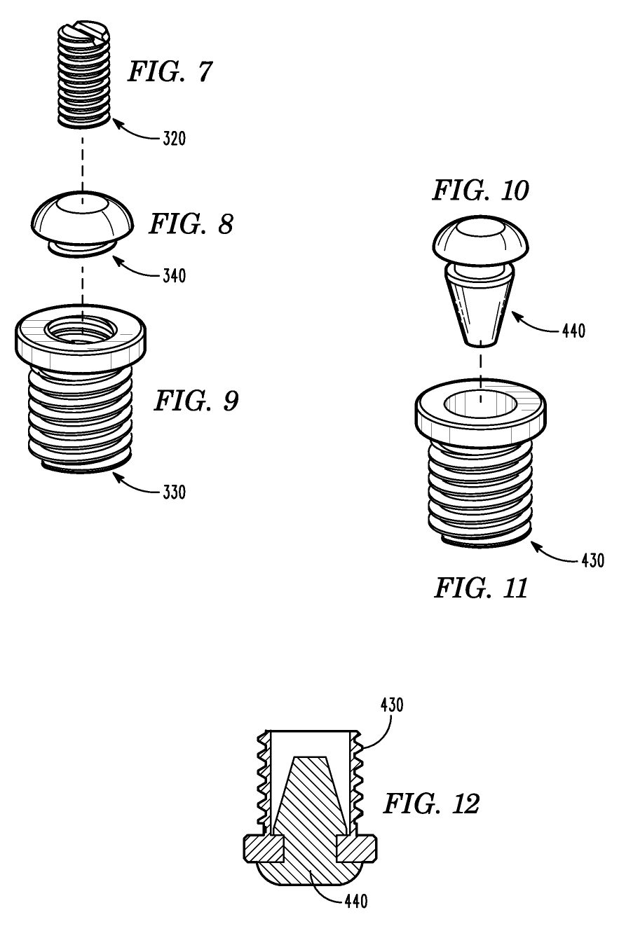

FIGS. 7-9 show a second exemplary embodiment of the invention. This embodiment includes a double threaded bushing 330, a set screw 320, and a foot 340. The operational relationship between set screw 320 and double threaded bushing 330 is similar to the relationship between set screw 220 and double threaded bushing 230. However, in this embodiment, double threaded bushing 330 threads directly into a threaded recess in an extension of grate 100 instead of into a separate bushing. In addition, in this example, double threaded bushing 330 has a flange-like feature at the end that receives foot 340. The flange-like feature can provide additional support for foot 340 and/or provide a gripping surface to assist insertion into the recess. The operation of adjusting this embodiment is similar to that of the embodiment shown in FIGS. 3-6. The slotted feature on the end of set screw 320 can be seen in FIG. 7.

A third exemplary embodiment of the invention is shown in FIGS. 10-12. This embodiment includes a threaded bushing 430 that has threads on only its outside surface. A foot 440 is inserted into a hole in the end of threaded bushing 430.

Threaded bushing 430 is threaded into the recess in the extension of grate 100 to locate foot 440 at the desired position. A tight fit between the threads of threaded bushing 430 and the threads of the recess is desirable in order to securely hold threaded bushing 430 in the desired position.

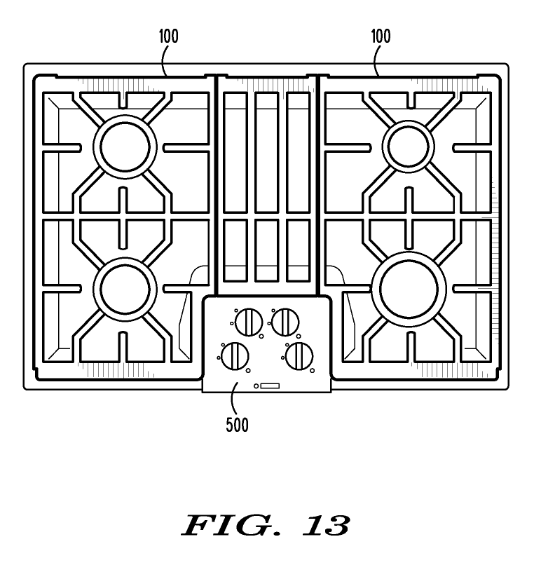

FIG. 13 shows an example of a home appliance in accordance with the invention. The home appliance shown in FIG. 13 is a cooktop 500 having a plurality of grates 100. Each grate 100 can have one or more adjustable foot assemblies as shown, for example, in FIGS. 3-12, as described above. Other examples of home appliances in accordance with the invention include, for example, gas ranges.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the invention.

What is claimed is:

1. An adjustable foot assembly for a pan support of a home appliance, the foot assembly comprising:
a first bushing having an inside threaded surface on an inner surface, and outside threaded surface on an outer surface;
a set screw having an outside threaded surface on an outer surface, the outside threaded surface of the set screw engaging the inside threaded surface of the first bushing such that the set screw is movable relative to the first bushing along a first direction; and
a contact foot attached to the first bushing,
wherein the first bushing and the set screw are adapted to allow the set screw to be moved relative to the first bushing as the set screw is moved into contact with the pan support, the relative movement being allowed by the outside threaded surface of the set screw moving relative to the inside threaded surface of the first bushing.

2. The assembly of claim 1, wherein a first end of the set screw is accessible for movement relative to the first bushing through an opening in a first end of the first bushing when the contact foot is not covering the opening.

3. The assembly of claim 2, wherein the opening is covered by the contact foot.

4. The assembly of claim 2, wherein the contact foot has an opening, and the set screw is accessible for movement relative to the first bushing through the opening in the contact foot when the contact foot is attached to the first bushing.

5. The assembly of claim 2, wherein the outside threaded surface of the first bushing is adapted to engage an inside threaded surface of a recess in the pan support.

6. The assembly of claim 5, wherein the first bushing is adapted to be positioned relative to the recess along the first direction by turning the first bushing relative to the recess.

7. The assembly of claim 6, wherein the first bushing is adapted to be held in position relative to the recess along the first direction by a force exerted on the inside threaded surface of the recess by the outside threaded surface of the first bushing caused by a second end of the set screw coming in contact with the recess.

8. The assembly of claim 2, further comprising a second bushing, the second bushing having
an inside threaded surface on an inner surface, the inside threaded surface engaging the outside threaded surface of the first bushing, and
an outer surface adapted to fixedly engage an inside surface of a recess in the pan support such that the second bushing is fixed relative to the recess.

9. The assembly of claim 8, wherein the first bushing is adapted to be positioned relative to the second bushing along the first direction by turning the first bushing relative to the second bushing.

10. The assembly of claim 9, wherein the first bushing is adapted to be held in position relative to the recess along the first direction by a force exerted on the inside threaded surface of the second bushing by the outside threaded surface of the first bushing caused by a second end of the set screw coming in contact with the recess or the second bushing.

11. A grate for a home appliance, the grate comprising:
a pan support having a recess; and
an adjustable foot assembly positioned at least partially in the recess, the foot assembly comprising:
a first bushing having an inside threaded surface on an inner surface, and outside threaded surface on an outer surface;
a set screw having an outside threaded surface on an outer surface, the outside threaded surface of the set screw engaging the inside threaded surface of the first bushing such that the set screw is movable relative to the first bushing along a first direction; and
a contact foot attached to the first bushing,
wherein the first bushing and the set screw are adapted to allow the set screw to be moved relative to the first bushing as the set screw is moved into contact with the recess, the relative movement being allowed by the outside threaded surface of the set screw moving relative to the inside threaded surface of the first bushing.

12. The grate of claim 11, wherein a first end of the set screw is accessible for movement relative to the first bushing through an opening in a first end of the first bushing when the contact foot is not covering the opening.

13. The grate of claim 12, wherein the opening is covered by the contact foot.

14. The grate of claim 12, wherein the contact foot has an opening, and the set screw is accessible for movement relative to the first bushing through the opening in the contact foot when the contact foot is attached to the first bushing.

15. The grate of claim 12, wherein the outside threaded surface of the first bushing engages an inside threaded surface of the recess.

16. The grate of claim 15, wherein the first bushing is positionable relative to the recess along the first direction by turning the first bushing relative to the recess.

17. The grate of claim 16, wherein the first bushing is held in position relative to the recess along the first direction by a force exerted on the inside threaded surface of the recess by the outside threaded surface of the first bushing caused by a second end of the set screw coming in contact with the recess.

18. The grate of claim 12, further comprising a second bushing, the second bushing having an inside threaded surface on an inner surface, the inside threaded surface engaging the outside threaded surface of the first bushing, and an outer surface fixedly engaging an inside surface of the recess such that the second bushing is fixed relative to the recess.

19. The grate of claim 18, wherein the first bushing is positionable relative to the second bushing along the first direction by turning the first bushing relative to the second bushing.

20. The grate of claim 19, wherein the first bushing is held in position relative to the recess along the first direction by a force exerted on the inside threaded surface of the second bushing by the outside threaded surface of the first bushing caused by a second end of the set screw coming in contact with the recess or the second bushing.

21. The grate of claim 17, further comprising a second adjustable foot assembly positioned at least partially in a second recess in the pan support.

22. An adjustable foot assembly for a pan support of a home appliance, the foot assembly comprising:
a bushing having an outside threaded surface on an outer surface, the outside threaded surface being adapted to engage an inside threaded surface of a recess in the pan support; and
a contact foot attached to the first bushing,
wherein the first bushing has a round cross section and the contact foot has a round contact patch for contacting the home appliance.

23. A home appliance, comprising:
a support surface;
a pan support located on the support surface and for supporting a pan to be positioned above the home appliance, the pan support having a recess; and
an adjustable foot assembly positioned at least partially in the recess, the foot assembly comprising:
a first bushing having an inside threaded surface on an inner surface, and outside threaded surface on an outer surface;
a set screw having an outside threaded surface on an outer surface, the outside threaded surface of the set screw engaging the inside threaded surface of the first bushing such that the set screw is movable relative to the first bushing along a first direction; and
a contact foot attached to the first bushing,
wherein the first bushing and the set screw are adapted to allow the set screw to be moved relative to the first bushing as the set screw is moved into contact with the recess, the relative movement being allowed by the outside threaded surface of the set screw moving relative to the inside threaded surface of the first bushing.

24. The home appliance of claim 23, wherein a first end of the set screw is accessible for movement relative to the first bushing through an opening in a first end of the first bushing when the contact foot is not covering the opening.
